(19) United States
(12) Patent Application Publication
(10) Pub. No.: US 2025/0023487 A1
(43) Pub. Date: Jan. 16, 2025

(54) POWER CONVERTER SYSTEM

(71) Applicant: HYPER POLAND ELECTRO S.A., Warsaw (PL)

(72) Inventors: Marek Michalczuk, Otowkowa (PL); Marcin Nikoniuk, Marco Polo (PL); Krzysztof Prusaczyk, Zagan (PL)

(73) Assignee: HYPER POLAND ELECTRO S.A., Warsaw (PL)

(21) Appl. No.: 18/712,148

(22) PCT Filed: Nov. 21, 2022
(86) PCT No.: PCT/EP2022/082558

§ 371 Date: May 21, 2024

(30) Foreign Application Priority Data
Nov. 22, 2021 (EP) 21209694.5

(51) Int. Cl. H02M 7/483; H02M 1/00; H02M 7/487; H02M 7/5395

(52) U.S. Cl. CPC H02M 7/4837; H02M 7/4833; H02M 7/487; H02M 7/5395; H02M 1/0095

(57) ABSTRACT

A power converter system includes a DC voltage source, a control system, a multilevel inverter and a balancing circuit connected to the DC voltage source, and at least two DC link series connected capacitors connected between a positive and a negative voltage supply line (V+, V−) of the DC voltage source and having a mid-point therebetween. The balancing circuit comprises a plurality of switches that are connected in series between said positive and a negative voltage supply line (V+, V−), the plurality of switches arranged in a first pair of switches and a second pair of switches. A flying capacitor is connected between a mid point of the first pair of switches and a mid point of the second pair of switches, and an inductor is connected between said DC link capacitor mid point and a mid point between the first pair of switches and second pair of switches.

The present invention relates to a power converter system having a multi-level inverter with auxiliary balancing circuit.

Compared to the more common two-level inverters, multi-level power inverters in electric drive application provide lower harmonic content of the stator current, higher efficiency, lower requirements for transistor blocking voltage, better loss distribution, and lower requirements for AC output filter. Neutral-point-clamped (NPC) inverters are the most widely used topology of multi-level inverters in high-power applications. In three-level topology the input DC circuit is divided into two parts with a neutral point NP situated between two link capacitors, whereby the best performance of the inverter is achieved with balanced voltages in the DC circuit.

The downsides of multi-level inverters compared to two-level inverters include a higher cost of the components and voltage unbalances in the DC link capacitors especially for operation with high reactive loads, however multi-level inverters are more suitable for numerous applications because of their relatively low THD (total harmonic distortion) coefficient in the output current, reduced switching losses, and lower requirements for transistor blocking voltage.

There are various known techniques to maintain the DC voltages balanced which can be divided into two categories. The first includes dedicated modulation algorithms, and the second includes additional hardware equipment. The drawback of modulation methods it that they have a limited range of effective operation, in particular they are not very effective for operation at high output voltage. The drawback of using additional hardware to balance DC voltages is the increased complexity and cost of the system.

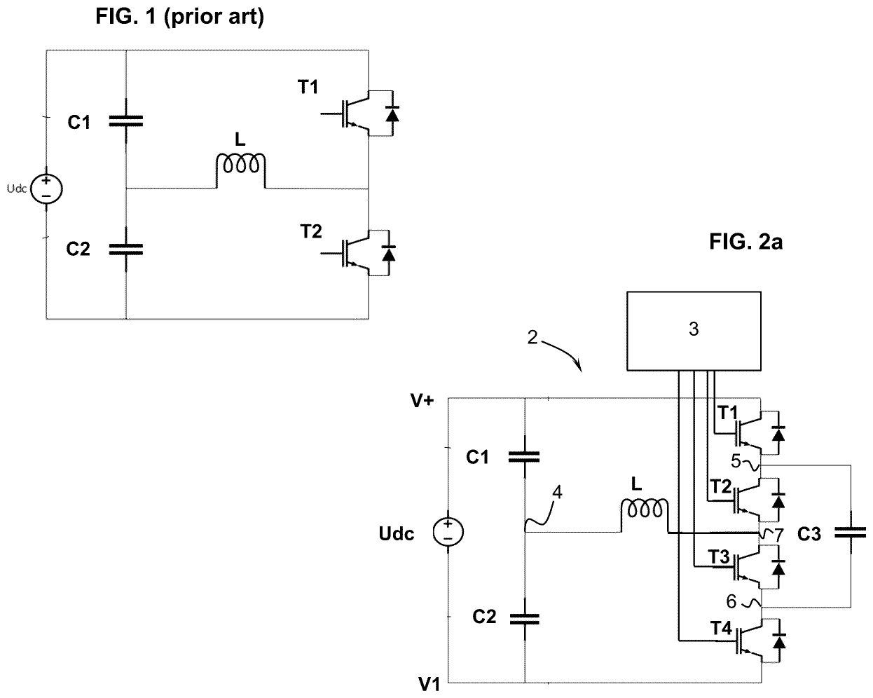

A known topology of the balancer for a three level NPC inverter is presented in FIG. 1. The main disadvantage of this topology is relatively high current ripples.

An object of the invention is to provide a power converter system with a multi-level inverter and balancing circuit for high power operations that has a stable current output and that is economical to produce and operate.

It is advantageous to provide a power converter system that is robust and reliable.

It is advantageous to provide a power converter system that is easy to drive.

Objects of the invention have been achieved by providing a multi-level inverter according to claim 1.

Disclosed herein is a power converter system comprising a DC voltage source (Udc), a control system, a multilevel inverter and a balancing circuit connected to the DC voltage source (Udc), and at least two DC link series connected capacitors (C1, C2) connected between a positive and a negative voltage supply line (V+, V−) of the DC voltage source (Udc) and having a mid-point therebetween The balancing circuit comprising a plurality of switches (T1, T2, T3, T4) that are connected in series between said positive and a negative voltage supply line (V+, V−), the plurality of switches arranged in a first pair of switches (T1, T2) and a second pair of switches (T3, T4), a flying capacitor (C3) connected between a mid point of the first pair of switches (T1, T2) and a mid point of the second pair of switches (T3, T4), and an inductor (L) connected between said DC link capacitor mid point and a mid point (7) between the first pair of switches (T1, T2) and second pair of switches (T3, T4).

The control system comprises a cascaded control loop including a first control path comprising a first controller (R1) and a second controller (R2), the first controller (R1) configured to receive a difference of DC link capacitor voltages (UC1, UC2) as input, the second controller (R2) configured to receive a difference between an output of the first controller (R1) and an inductor current (i_L) as input and configured to output a current control signal (Ti). The control system further comprises a second control path configured to receive a flying capacitor voltage (UC3) as input and configured to output a voltage control signal (Tu). The control system further comprises a switch control circuit configured to receive the current control signal (Ti) and the voltage control signal (Tu) as input and configured to control operation of the plurality of switches (T1, T2, T3, T4) of the balancing circuit.

In an advantageous embodiment, the first and second controllers (R1, R2) are proportional-integral controllers.

In an advantageous embodiment, the second control path comprises a third controller (R3) configured to receive a difference between the flying capacitor voltage (UC3) and a reference voltage (UC3_ref) as input and the second control path further comprises a multiplication block (M1) configured to multiply the output of the third controller (R3) with the sign of the inductor current (i_L) obtained by a sign function block (S1) to form the voltage control signal (Tu).

In an advantageous embodiment, the third controller (R3) is a proportional-integral controller.

In an advantageous embodiment, the control system further comprises a compensation circuit arrangement for compensating the influence of the voltage control signal (Tu) on an average value of the inductor current (i_L) over a switching cycle, the compensation circuit arrangement configured to receive a positive compensation voltage control signal (Tup) and a negative compensation voltage control signal (Tun) from the second control path, the compensation circuit arrangement configured to generate a compensation control signal (Tx) for input into the switch control circuit.

In an advantageous embodiment, the second control path comprises a first saturation block (L1) and second saturation block (L2) configured to receive the voltage control signal (Tu), the first saturation block having a lower limit of 0 and an upper limit of a fixed positive value and the second saturation having an upper limit of 0 and a lower limit of a fixed negative value, the first saturation block configured to output a positive compensation voltage control signal (Tup) and the second saturation block configured to output a negative compensation voltage control signal (Tun), the compensation circuit arrangement (12) configured to receive said positive and negative compensation voltage control signals (Tup, Tun).

In an advantageous embodiment, the compensation circuit arrangement is configured to output the compensation control signal according to the formula Tx=(UC1−UC3)/UC2*Tup−(UC2−UC3)/UC1*Tun.

In an advantageous embodiment, the switch control circuit comprises a first subtraction block (D7) configured to add the current control signal (Ti) and voltage control signal (Tu) and subtract the compensation control signal (Tx), and a second subtraction block (D8) configured to add the current control signal (Ti) and subtract the voltage control signal (Tu) and compensation control signal (Tx).

In an advantageous embodiment, each of the first and second subtraction blocks (D7, D8) is configured to add a reference (constant) value.

In an advantageous embodiment, the gate control circuit is configured to generate first and second PWM carrier signals (W1, W2) and further comprises a first comparator (Co1) configured to compare the output of the first subtraction block (D7) with the first PWM carrier signal (W1) and a second comparator (Co2) configured to compare the output of the second subtraction block (D8) with the second PWM carrier signal (W2).

In an advantageous embodiment, the first and second PWM carrier signals (W1, W2) have the same frequency and amplitude, and have substantially triangular waveforms, whereby the first PWM carrier signal (W1) is 180° phase shifted from the second PWM carrier signal (W2).

In an advantageous embodiment, the plurality of switches (T1, T2, T3, T4) are transistors and the output of the comparators (Co1, Co2) constitute transistor gate input signals.

In an advantageous embodiment, the switch control circuit is configured to generate switch control signals (T1control, T2control, T3control, T4control) to control operation of the plurality of switches (T1, T2, T3, T4) of the balancing circuit, wherein the switch control signals (T1control, T2control, T3control, T4control) are periodic and include two switching states per switching cycle if Tu=Tx=Ti=0 and three switching states per switching cycle otherwise.

In an advantageous embodiment, the multi-level inverter is a three-level inverter.

Further objects and advantageous features of the invention will be apparent from the claims, from the detailed description, and annexed drawings, in which:

FIG. 1 is a schema of a prior art balancing circuit for a three-level inverter circuit;

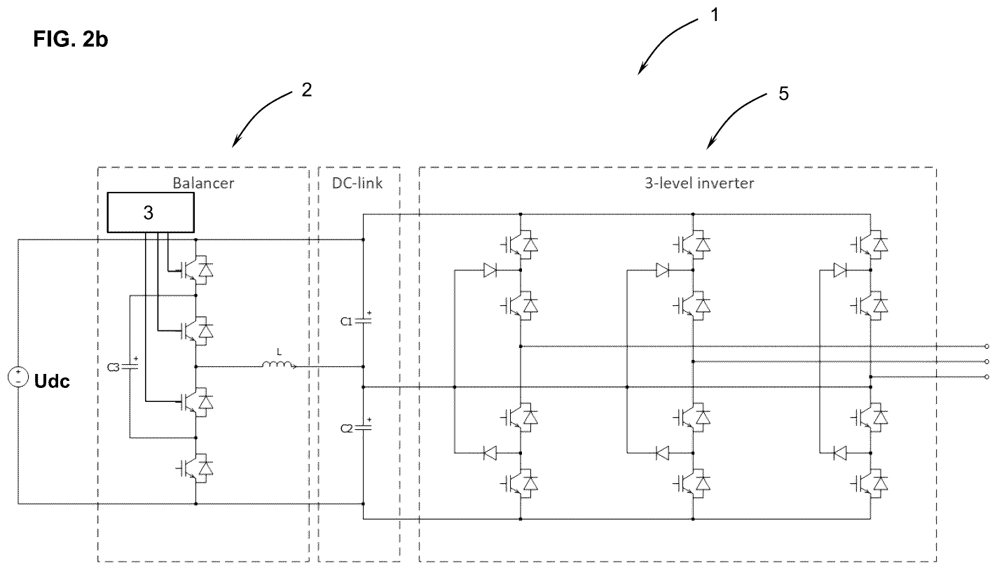

FIG. 2a is a schema of a balancing circuit for a three-level inverter circuit of a power converter system according to an embodiment of the invention;

FIG. 2b is a schema of a power converter system with a three-level inverter and a balancing circuit according to an embodiment of the invention;

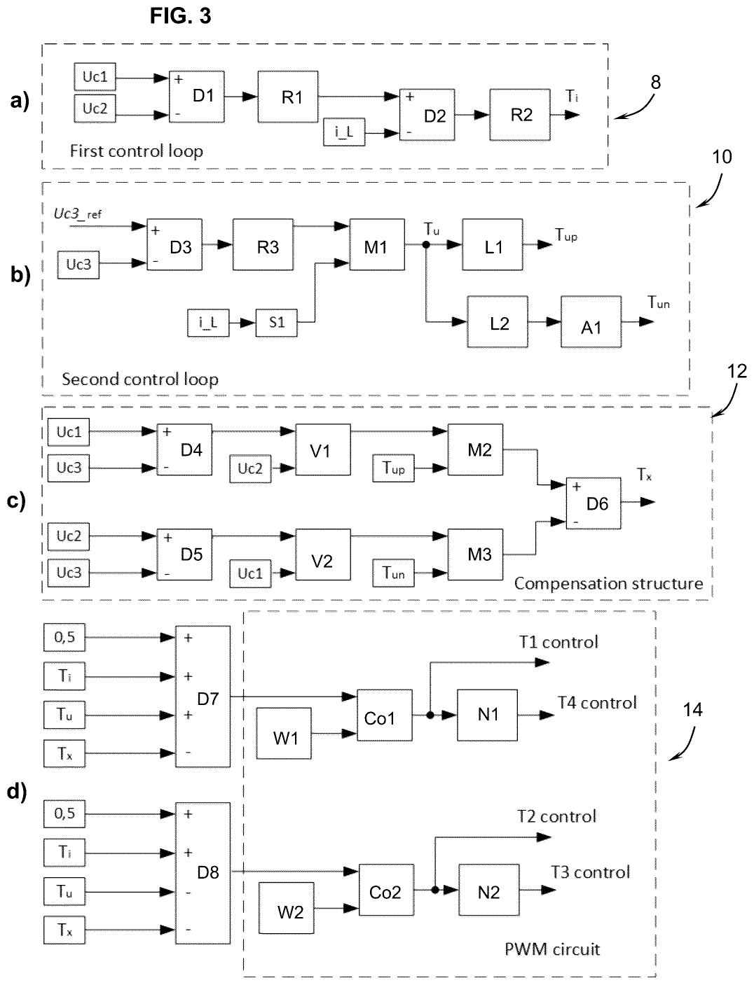

FIGS. 3a to 3d illustrate control systems of a balancing circuit of a power converter system according to embodiments of the invention;

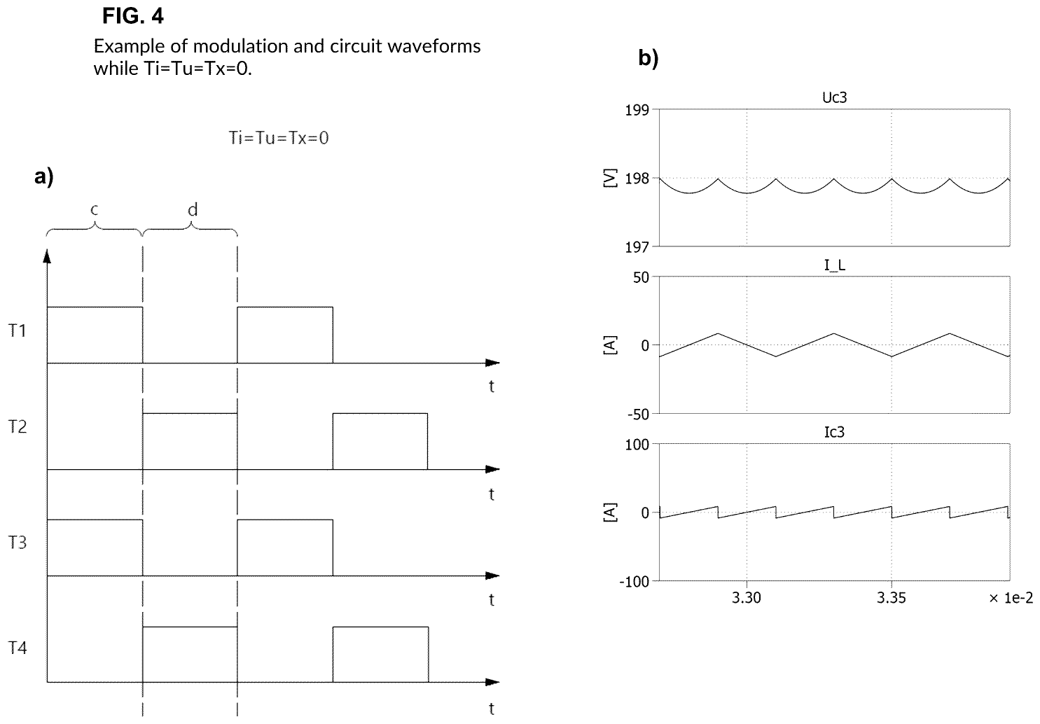

FIGS. 4a and 4b show plots, over time, of balancing circuit signals: (a) transistor switching signals (circuit modulation signals) and (b) circuit voltage and current signals (Uc3 voltage across the flying capacitor C3, I_L current through inductor L, Ic3 current flowing into flying capacitor C3) while Ti=Tu=Tx=0 according to embodiments of the invention;

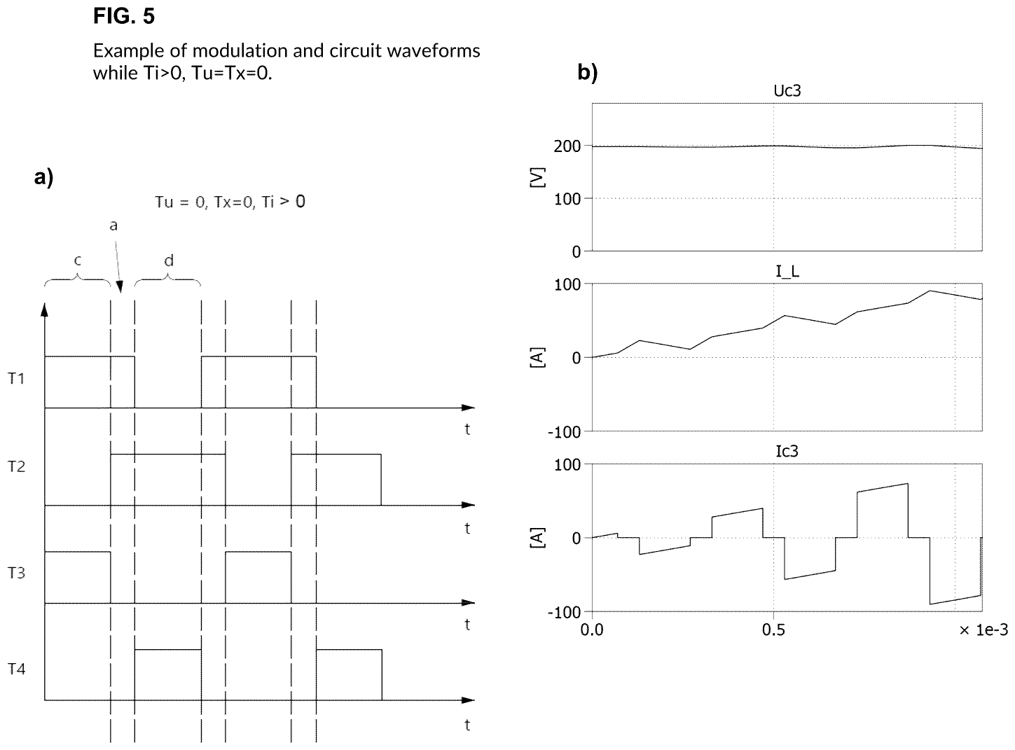

FIGS. 5a and 5b show plots similar to FIGS. 4a and 4b while Ti>0, Tu=Tx=0;

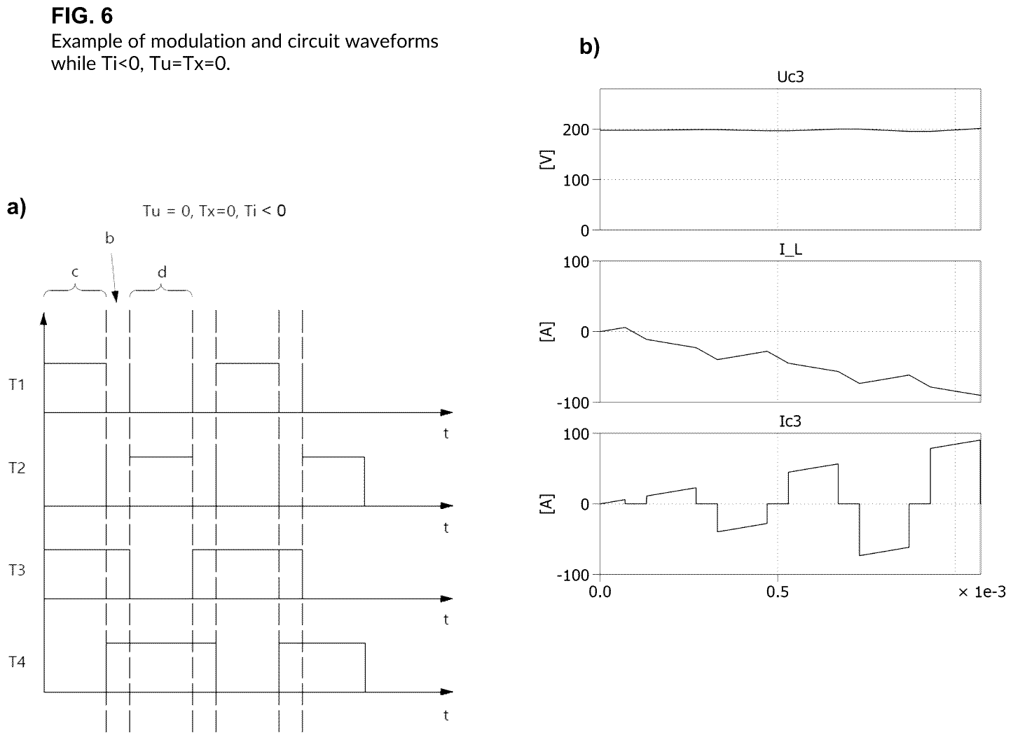

FIGS. 6a and 6b show plots similar to FIGS. 4a and 4b while Ti<0, Tu=Tx=0;

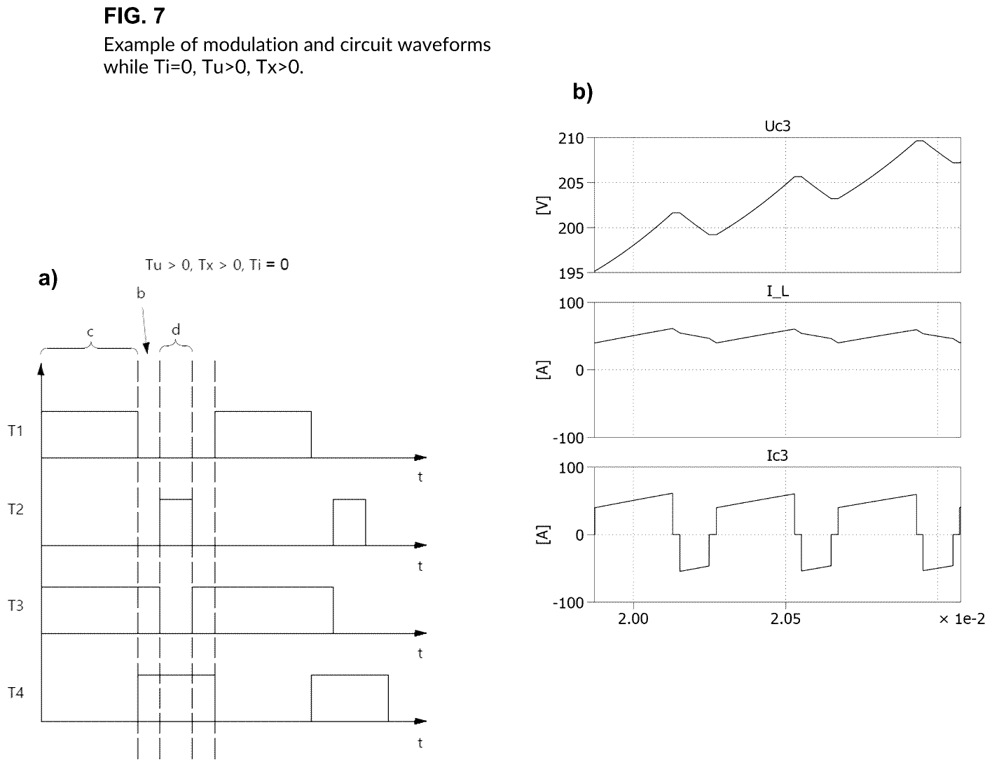

FIGS. 7a and 7b show plots similar to FIGS. 4a and 4b while Ti=0, Tu>0, Tx>0;

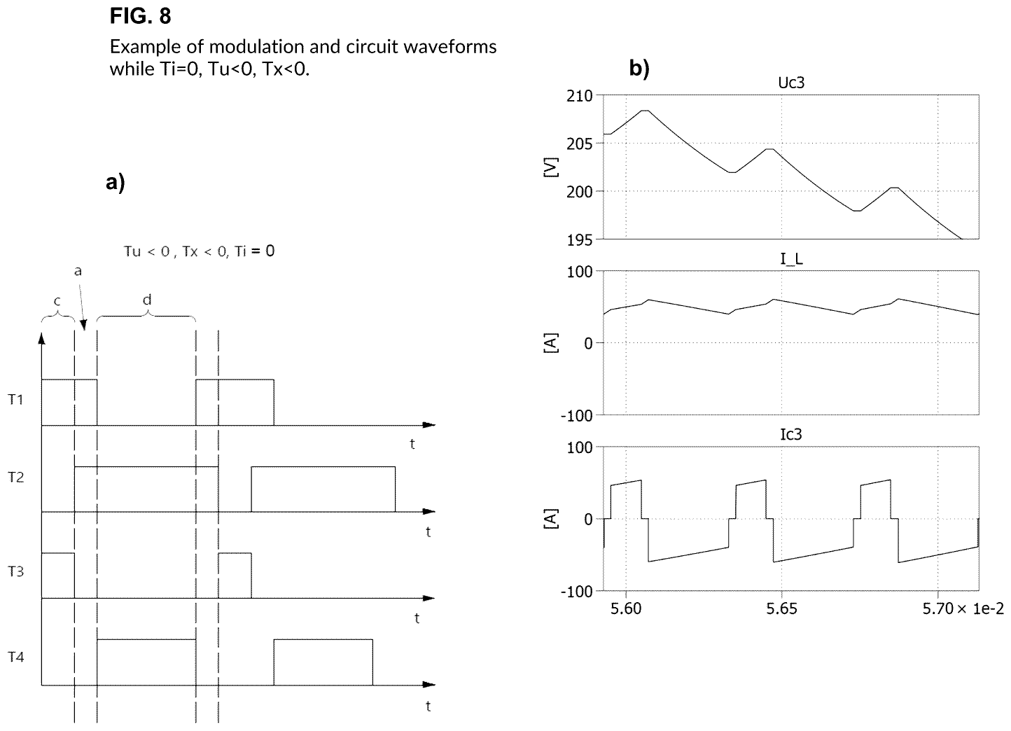

FIGS. 8a and 8b show plots similar to FIGS. 4a and 4b while Ti=0, Tu<0, Tx<0;

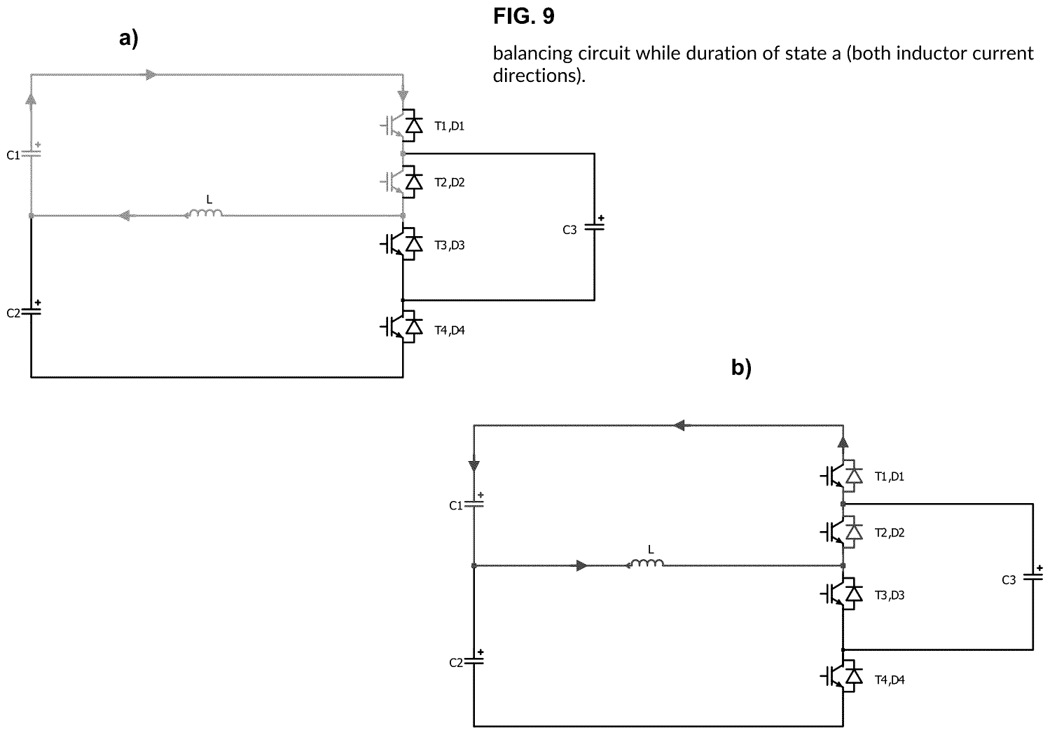

FIGS. 9a and 9b show a portion of the circuit of FIG. 2a illustrating a flow of current in the circuit (in both directions across the inductor L) during a first state identified in the plots of FIG. 4a-8a as state a;

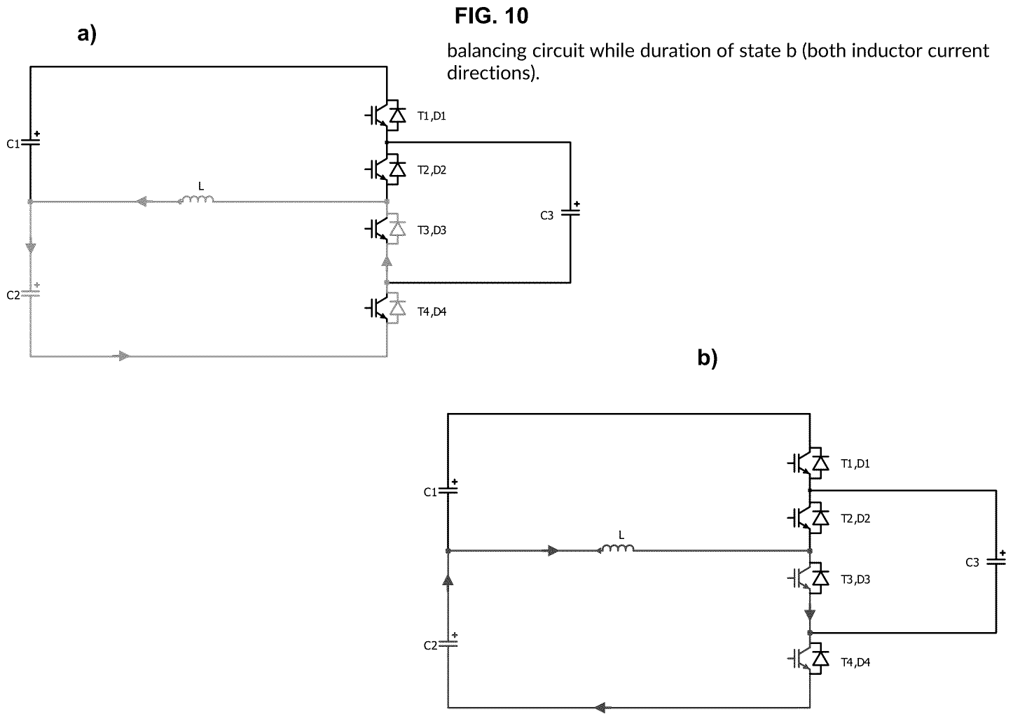

FIGS. 10a and 10b are similar to FIGS. 9a and 9b during a second state identified as state b;

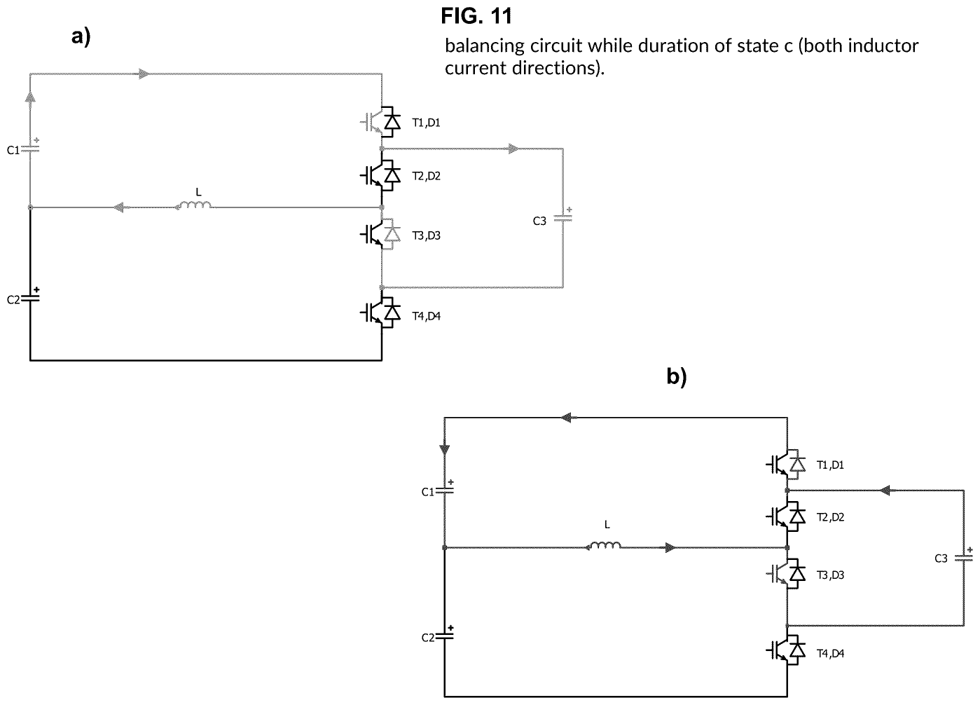

FIGS. 11a and 11b are similar to FIGS. 9a and 9b during a third state identified as state c;

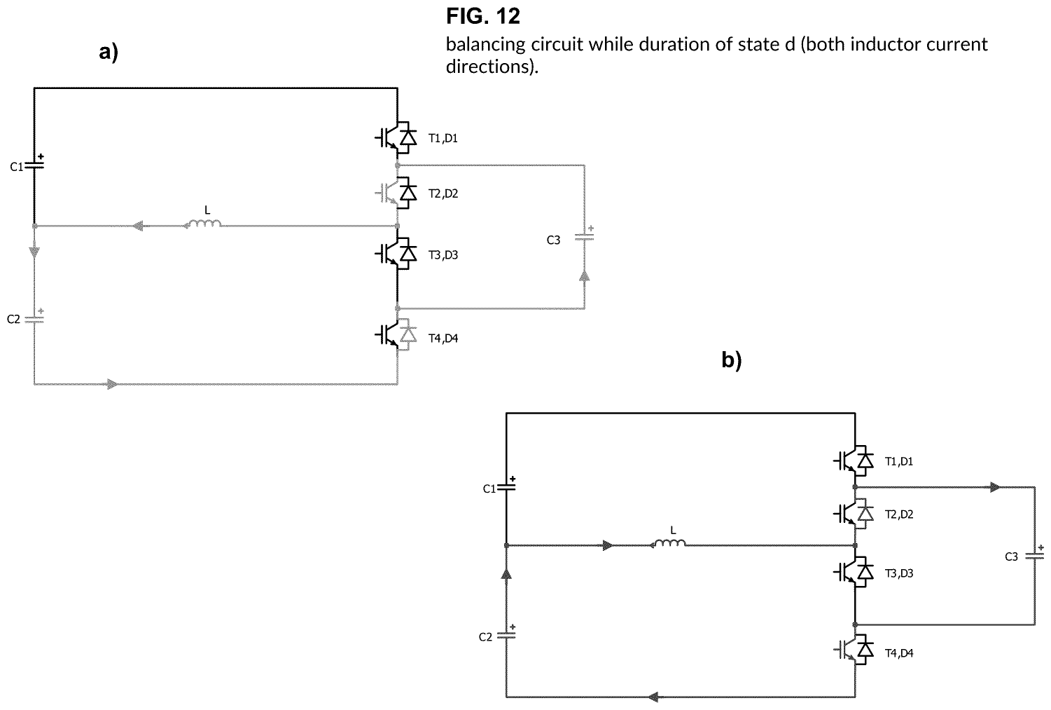

FIGS. 12a and 12b are similar to FIGS. 9a and 9b during a fourth state identified as state d;

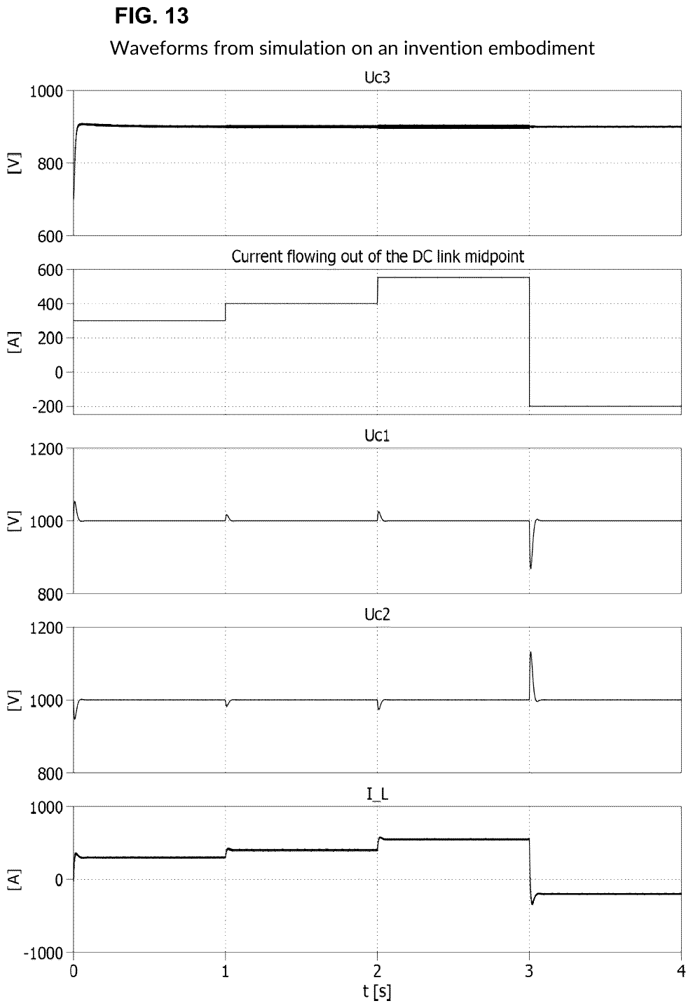

FIG. 13 shows plots, over time, of balancing circuit voltage and current signals: Uc3 voltage across the flying capacitor C3, Current flowing out of DC link midpoint, I_L current through inductor L, Uc1 voltage across the first DC link capacitor C1, Uc2 voltage across the second DC link capacitor C2, I_L current through inductor L) according to embodiments of the invention;

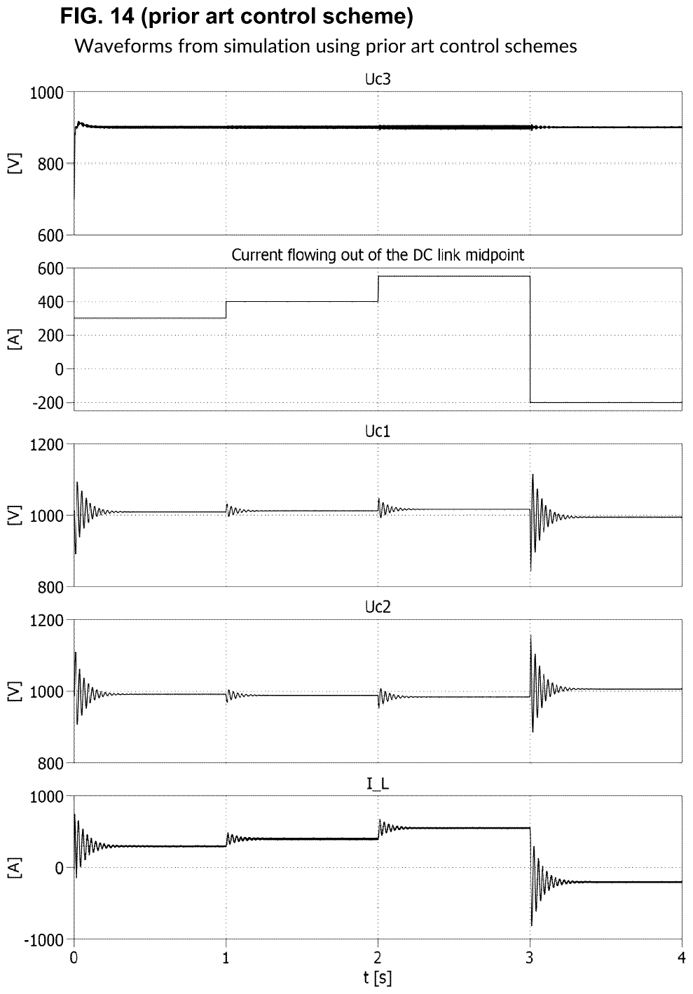

FIG. 14 shows plots, over time, of circuit voltage and current signals similar to FIG. 13 but using a conventional (prior art) control system;

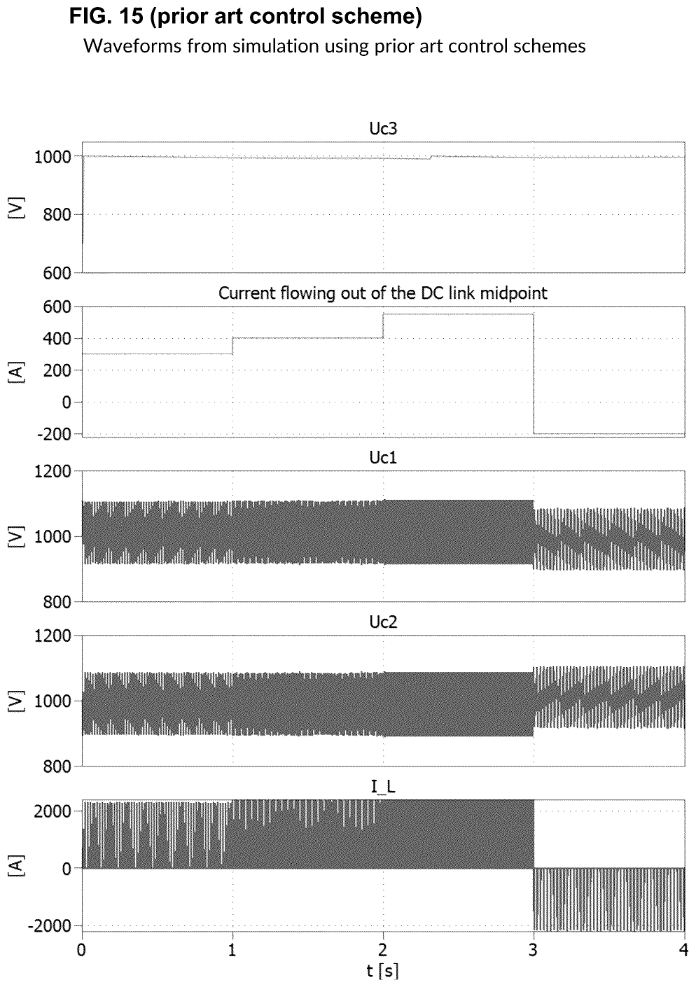

FIG. 15 shows plots, over time, of circuit voltage and current signals similar to FIG. 13 but using another conventional (prior art) control system;

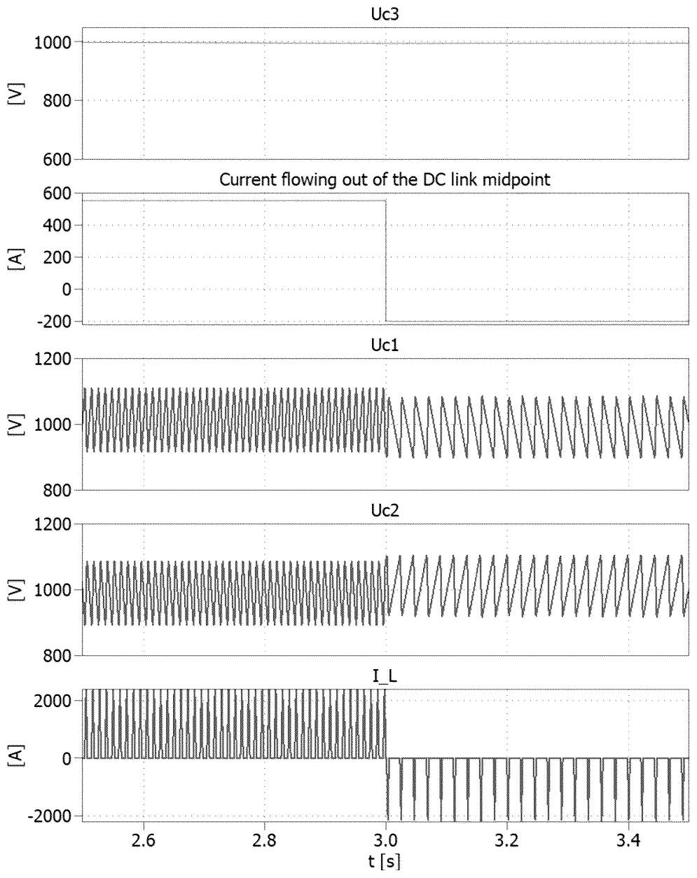

FIG. 16 shows the plots of FIG. 15 zoomed in to a period of 1 second;

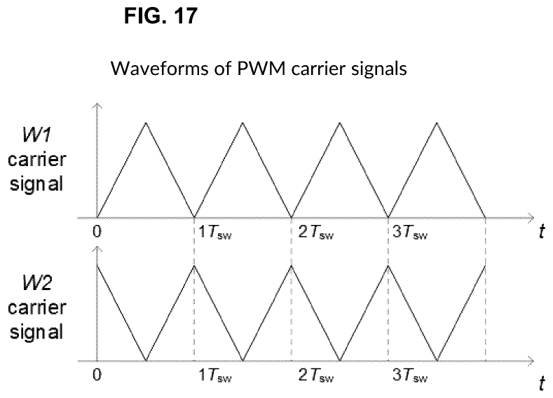

FIG. 17 shows waveforms of PWM carrier signals of a gate control circuit of a multi-level inverter drive according to embodiments of the invention.

Referring to the figures, starting with FIG. 2a, 2b, a power converter system 1 according to embodiments of the invention comprises a multi-level inverter circuit 5, a balancing circuit 2, and a control system 3 connected to balancing circuit 2.

The power converter system 1 in the illustrated embodiment of FIG. 2b comprises a three-level inverter circuit 5 with a balancing circuit 2, comprising a DC voltage source Udc, and first and second series connected DC link capacitors C1, C2 connected between the plus and minus poles of the DC voltage source.

The balancing circuit 2 comprises a first pair of switches T1, T2 and a second pair of switches T3, T4 connected in series between the plus and minus poles of the DC voltage source, a flying capacitor C3 connected between a mid point 5 of the first pair of switches T1, T2 and a mid point 6 of the second pair of switches T3, T4, and an inductor L connected between a mid point 4 between the DC link capacitors C1, C2 and a mid point 7 between the first pair of switches T1, T2 and second pair of switches T3, T4.

The switches are formed by transistors, the gate (i.e. base) of each transistor being connected to the control system 3. Each transistor comprises a diode interconnecting the emitter side of transistor to the collector side of the transistor, the diode anode connected to the emitter and the diode cathode connected to the collector, configured for current flow allow discharging of capacitors when the transistor switch is open (off).

The mid point 4 of the DC link capacitors forms a neutral point (NP) for the three-level inverter 5.

The control system 3 comprises functional blocks, which are defined as follows.
Subtraction blocks (D1, D2, D3, D4, D5, D6, D7, D8). A subtraction block is a multi-input single-output block, where the output signal is a difference between the sum of signals from plus type inputs (minuend) and the sum of signals from minus type inputs (subtrahend).
Multiplication blocks (M1, M2, M3). The output signal of a multiplication block is a multiplication of the input signals.
Sign function block (S1). The output signal of a sign function block is defined based on the sign of the input signal as follows: the output is 1 for positive input, −1 for negative input and 0 for the value zero of the input.
Division blocks (V1, V2). The output signal of a division block is the signal from the top input (dividend) divided by the signal from the bottom input (divisor).
Triangular wave generators (W1, W2). The output of a triangular wave generator is a triangular wave form, e.g., with a minimum value of 0 and a maximum value of 1 as shown in FIG. 17.
Comparators (Co1, Co2). A comparator compares two input signals. The output is 1 if the signal from the top input is greater than the signal from the bottom input. The output is 0 if the signal from the bottom input is greater than the signal from the top input. The output does not change if both input signals are equal.
Signal negation blocks (N1, N2). The output signal is the negation of the input signal.
Proportional-integral controllers:
   R1—DC link voltages difference proportional-integral controller
   R2—inductor current proportional-integral controller
   R3—C3 capacitor voltage proportional-integral controller
The output signal is a sum with a first summand proportional to the input signal and a second summand proportional to the integral of input signal.
Signal amplification block (A1). The output signal of a signal amplification block is the input signal multiplied by a static gain.
Saturation blocks (L1, L2). A saturation block limits a signal to an upper and lower value. If the input signal is within the saturation limits, the output signal is identical to the input signal. L1 limits are as follows: the lower limit is 0, the upper limit is a fixed positive value, e.g., 1; L2 limits are as follows: the lower limit is a fixed negative value, e.g., −1, the upper limit is 0.

The control system 3 comprises a cascaded control loop comprising a first control path 8 and a second control path 10 configured to maintain the DC link capacitor voltages balanced. It may be noted that with a non-cascaded single control loop, optimal balanced operation of inverter circuit is very difficult because the voltage on the flying capacitor C3 tends to be unstable. To solve this problem, a second control path is applied. The parallel second control path 10 maintains the voltage on the flying capacitor C3 constant but does not affect the control process carried out in the first control path 8.

The first control path 8 (current control loop) comprises a first subtraction block D1, a DC link voltages difference proportional-integral controller R1 receiving an output of the first subtraction block, a second subtraction block D2, and an inductor current proportional-integral controller R2 outputting a current control signal Ti. In the first control path 8, the voltages Uc1, Uc2 across the first and second link capacitors C1, C2 respectively are input into a first subtraction block D1 to calculate a difference between the voltages that is input into the DC link voltages difference proportional-integral controller R1 which outputs the result to the second subtraction block D2. A value of the inductor current i_L is input in the second subtraction block which outputs the difference into the inductor current proportional-integral controller R2 to calculate the current control signal Ti.

Thus, the first control path 8 comprises two proportional-integral controllers R1, R2 arranged in a cascade with different feedbacks. The feedback of the DC link voltages difference proportional-integral controller R1 is the difference between the voltages Uc1 and Uc2. The feedback of the inductor current proportional-integral controller R2 is the inductor current i_L. The output of R1 is a reference inductor current, i.e., a desired inductor current. The output of R2 is a control signal corresponding to the desired inductor voltage.

The second control path 10 (voltage control loop) comprises a third subtraction block D3, a flying capacitor voltage proportional-integral controller R3 receiving an output of the third subtraction block, and a first multiplication block M1 receiving the output of the flying capacitor voltage proportional-integral controller R3 and outputting a voltage control signal Tu. In the second control path 10, the voltage Uc3 across the flying capacitor C3 and a reference voltage Uc3_ref respectively are input into the third subtraction block D3 to calculate a difference between the voltages that is input into the flying capacitor voltage proportional-integral controller R3 which outputs the result to the first multiplication block M1. The sign of the inductor current i_L (obtained by a sign function block S1) is input in the multiplication block M1 which outputs the product of the sign of the inductor current i_L and of the output of the flying capacitor voltage proportional-integral controller R3 to form the voltage control signal Tu.

The second control path 10 further comprises a first saturation block L1 and second saturation block L2 receiving an output of the first multiplication block M1, namely the voltage control signal Tu. The first saturation block L1 has a lower limit of 0 and an upper limit of a fixed positive value e.g. 1 and the second saturation block L2 has an upper limit of 0 and a lower limit of a fixed negative value e.g. −1. The first saturation block L1 outputs a positive compensation voltage control signal Tup and second saturation block L2 outputs a negative compensation voltage control signal Tun. At least one of the saturation blocks, for instance the second saturation block L2, may be further connected to an amplifier A1 to invert the corresponding compensation voltage control signal (the gain of A1 is −1).

The control system 3 further comprises a compensation circuit arrangement 12 to generate a compensation control signal Tx which seeks to adjust correction of voltage imbalances taking into account the differences between the voltages of the DC link capacitors and the flying capacitor C3. The compensation control signal Tx allows to maintain the desired average value of the choke current in a given switching cycle. This parameter is useful because it compensates the influence of the voltage control signal Tu on the average value of the inductor current i_L.

The compensation circuit arrangement 12 comprises a fourth subtraction block D4 and a fifth subtraction block D5, the fourth subtraction block outputting a difference between the first link capacitor voltage Uc1 and the flying capacitor voltage Uc3 which is fed into a first division block V1, and the fifth subtraction block outputting a difference between the second link capacitor voltage Uc2 and the flying capacitor voltage Uc3 which is fed into a second division block V2. The first division block V1 divides the first difference with the second link capacitor voltage Uc2 and the second division block V2 divides the second difference with the first link capacitor voltage Uc1. The output of the first division block V1 is fed into a second multiplication block M2 and multiplied with the positive compensation voltage control signal Tup, and the output of the second division block V2 is fed into a third multiplication block M3 and multiplied with the negative compensation voltage control signal Tun. The outputs of the second and third multiplication blocks M2, M3 are fed into a sixth subtraction block D6 to calculate a difference that forms the compensation control signal Tx.

The control system 3 further comprises a transistor gate input circuit arrangement 14 to generate control signals T1control, T2control, T3control, T4control for controlling the switching of transistor switches T1, T2, T3, T4 respectively. The transistor gate input circuit arrangement 14 comprises a seventh subtraction block D7 and an eighth subtraction block D8, into which the current control signal Ti, voltage control signal Tu and compensation control signal Tx are inputted. In the seventh subtraction block D7, the current control signal Ti and voltage control signal Tu are added and the compensation control signal Tx is subtracted. In the eighth subtraction block D8, the current control signal Ti is added and the voltage control signal Tu and compensation control signal Tx are subtracted. A constant reference value, for instance a mean value between switch control values 0 and 1 (i.e. 0.5), may be added in both subtraction blocks D7, D8 so that the signal oscillates about the reference value. The transistor gate input circuit arrangement 14 further comprises a first comparator Co1 comparing the output of the seventh subtraction block D7 with a first PWM (pulse width modulated) carrier signal W1 and a second comparator Co2 comparing the output of the eighth subtraction block D8 with a second PWM (pulse width modulated) carrier signal W2. The PWM carrier signals have the same frequency and amplitude, and may preferably have substantially triangular waveforms, whereby the first carrier signal W1 is 180° phase shifted from the second PWM carrier signal W2. The output of the comparators Co1, Co2 constitute the transistor switching control signals which may substantially correspond to a binary output signal of either switch ON or switch OFF.

The control signal T1control of the first transistor switch T1 and the control signal T4control of the fourth transistor switch T4 are outputted by the first comparator Co1, whereby the control signals of one transistor is opposed to the control signal of the other transistor by a first negation block N1, and the control signal T2control of the second transistor switch T2 and the control signal T3control of the third transistor switch T3 are outputted by the second comparator Co2, whereby the control signals of one transistor is opposed to the control signal of the other transistor by a second negation block N2.

The control signals T1control, T2control, T3control, T4control generated by the transistor gate input circuit arrangement 14 are pulse trains with a constant frequency and a variable duty cycle as illustrated in FIGS. 4a, 5a, 6a, 7a, and 8a.

It is possible to control both the DC link capacitor C1, C2 voltages and the flying capacitor C3 voltage using four switching states illustrated in FIGS. 9 to 12.

In a first state, state a, illustrated in FIGS. 9a and 9b (showing both current directions), both first and second transistor switches T1 and T2 of the first pair are ON (the other switches T3, T4 being off), the voltage across the inductor L equals the voltage UC1 of the first DC link capacitor C1, and the current Ic3 flowing into the flying capacitor C3 is zero. That means the inductor current IL is rising and the flying capacitor voltage UC3 is not changing.

Similarly in state b, illustrated in FIGS. 10a and 10b (showing both current directions), both third and fourth transistor switches T3 and T4 of the second pair are ON (the other switches T1, T2 being off), the voltage across the inductor L equals the voltage UC2 of the second DC link capacitor C2, and the current Ic3 flowing into the flying capacitor C3 is zero.

In state c, illustrated in FIGS. 11a and 11b, (showing both current directions) first switch T1 and third switch T3 of the first and second transistor pair respectively are ON (the other switches T2, T4 being off), the voltage across the inductor L equals the difference between the first DC link capacitor voltage UC1 and the flying capacitor voltage UC3 (UC1-UC3), and the flying capacitor current/C3 equals the inductor current IL. That means the inductor current IL is rising and the flying capacitor C3 is charging for a positive inductor current IL (FIG. 11a) and discharging for a negative inductor current IL (FIG. 11b).

Similarly, in the state d, illustrated in FIGS. 12a and 12b (showing both current directions), the second and fourth switches T2 and T4 of the first and second transistor pair respectively are ON (the other switches T1, T3 being off), the voltage across the inductor L equals the difference between the flying capacitor voltage UC3 and the second DC link capacitor voltage UC2 (UC3-UC2) and the flying capacitor current IC3 equals the inductor current IL. That means the inductor current IL is rising and the flying capacitor C3 is charging for a positive inductor current/L (FIG. 12a) and discharging for a negative inductor current IL (FIG. 12b).

For the above described modulation, each switching cycle includes up to three switching states.

When the two control loops 10, 12 produce zero output signals (Ti=0, Tu=0), the switching cycle includes two symmetrical states, namely state c and state d as presented in FIG. 4.

If the DC voltages are balanced, the average inductor voltage and average flying capacitor current IC3 are zero, so the average values of the inductor current IL and flying capacitor voltage UC3 remain unchanged.

When the first control loop 8 produces a non-zero current control signal Ti, then state a or state b are added to the switching sequence.

For a positive current control signal Ti the inductor current IL is increasing as presented in FIG. 5. For a negative current control signal Ti, the inductor current IL is decreasing as presented in FIG. 6.

When the voltage control signal Tu is zero, the symmetry between state c and state d is preserved, so in the ideal case (neglecting losses and measurement inaccuracy), the average value of the flying capacitor voltage UC3 remains unchanged.

When the voltage control signal Tu is non-zero the duration times of state c and state d are different. This means the average value of the flying capacitor current IC3 is non-zero and the capacitor state of charge changes over the switching cycle. The voltage control signal Tu determined by the second control loop 10 affects also the average inductor voltage over the switching cycle. This effect is undesirable. Thus, the compensation control signal Tx, to overcome this effect, is added to the control process. Due to the compensation circuit arrangement 12, the change of inductor current IL is affected only by the current control loop 8.

By adding the compensation component signal the average value of the inductor voltage over the switching cycle might be kept unchanged while the charging/discharging ratio for the flying capacitor C3 is adjusted.

The optimal determination of the time duration of the switching states is an important advantage of the invention.

FIG. 13 shows plots obtained in a simulation study of an embodiment of the invention illustrated in FIGS. 2 and 3. Plots obtained in simulation studies of two of the currently existing solutions are presented in FIG. 14 [C. Dongdong et al, “A Novel Hybrid Voltage Balance Method for Five-Level Diode-Clamped Converters,” in IEEE Transactions on Industrial Electronics, vol. 65, no. 8, pp. 6020-631 Aug. 2018] and in FIGS. 15 and 16 [A. Shukla et al, “Flying-Capacitor-Based Chopper Circuit for DC Capacitor Voltage Balancing in Diode-Clamped Multilevel Inverter,” in IEEE Transactions on Industrial Electronics, vol. 57, no. 7, pp. 2249-2261 Jul. 2010]. The initial conditions and circuit parameters are the same in all of the tests (FIGS. 13-16). As shown in FIGS. 14-16, there are high oscillations in presented waveforms of the prior art. These oscillations can be slightly damped by adding additional resistance in series with the inductor L. However, this leads to changing the values of the voltages in the DC link capacitors C1, C2 in the steady state. The waveforms in the proposed invention have substantially no oscillations and the values of the voltages in the DC link capacitors C1, C2 are substantially constant and equal in the steady state.

As previously described in relation to FIG. 3, the duty cycle of transistors T1 and T2 is obtained in subtraction blocks D7 and D8 as a sum of 0.5, the current control signal Ti, the negation of the compensation control signal −Tx, and the voltage control signal Tu or its negation −Tu, respectively. Transistor gate signals are generated by a Pulse Width Modulator (PWM) circuit. In the proposed solution the PWM carrier signal generators W1 and W2 generate substantially triangular carrier signals in opposite phase as presented in FIG. 17. The gate signals for the first and second transistors T1 an T2 are obtained as logic complementary signals to the gate signals for the fourth and third transistors T4 and T3 respectively.

An advantageous aspect of the invention concerns the control method of the balancing circuit with a flying capacitor which allows keeping the DC link voltages and the flying capacitor voltage substantially constant by optimal selection and time determination of switching states in the switching cycle. The control method leads to no or low oscillations, low delays in the control system, and robustness against measurement offset and noise.

Another advantageous aspect of the invention is that the control method of the balancing circuit allows a simultaneous controlling of the DC link voltages and the flying capacitor voltage in a single mode of operation.

The above described control system and methods can be applied not only to three-level NPC converters but also to five and higher level converters. It can be advantageously used in various power electronic applications where the midpoints series-connected capacitors or batteries are accessible, and a voltage unbalance occurs.

### LIST OF REFERENCES

Power converter system (Drive system) 1
   Multi-level inverter 5
   Balancing circuit 2
      DC Voltage source Udc
      Link capacitors C1, C2
      Inductor L
      Flying capacitor C3
      Mid-point (Neutral Point NP for a 3 level inverter) 4
      Switches (Transistors) T1, T2, T3, T4
      Transistor pairs mid point 7
   Control system 3
   First control path (current control path) 8
      D1—subtraction block
      D2—subtraction block
      R1—DC link voltages difference proportional-integral controller
      R2—inductor current proportional-integral controller
   Second control path (voltage control path) 10
      D3—subtraction block
      R3—C3 capacitor voltage proportional-integral controller
      S1—realization of the sign function (1 for positive values, −1 for negative values and 0 for 0 value)
   M1—multiplication block
   L1—saturation block (lower limit 0, upper limit 1)
   L2—saturation block (lower limit −1, upper limit 0)
   A1—signal amplification
   Compensation control circuit 12
      D4—subtraction block
      D5—subtraction block
      D6—subtraction block
      V1—division block
      V2—division block
      M2—multiplication block
      M3—multiplication block
   Switch control circuit 14
      D7—subtraction block
      D8—subtraction block
      W1—triangular wave generator
      W2—triangular wave generator
      Co1—comparison of signals
      Co2—comparison of signals
      N1—signal negation
      N2—signal negation

1.-14. (canceled)

15. A power converter system comprising a DC voltage source, a control system, a multilevel inverter and a balancing circuit connected to the DC voltage source, and at least two DC link series connected capacitors connected between a positive and a negative voltage supply line of the DC voltage source and having a mid-point therebetween, the balancing circuit comprising a plurality of switches connected in series between said positive and a negative voltage supply line (V+, V−), the plurality of switches arranged in a first pair of switches and a second pair of switches, a flying capacitor connected between a mid point of the first pair of switches and a mid point of the second pair of switches, and an inductor connected between said DC link capacitor mid point and a mid point between the first pair of switches and second pair of switches, wherein said control system comprises a cascaded control loop including a first control path comprising a first controller and a second controller, the first controller configured to receive a difference of DC link capacitor voltages as input, the second controller configured to receive a difference between an output of the first controller and an inductor current as input and configured to output a current control signal, the control system further comprising a second control path configured to receive a flying capacitor voltage as input and configured to output a voltage control signal, the control system further comprising a switch control circuit configured to receive the current control signal and the voltage control signal as input and configured to control operation of the plurality of switches of the balancing circuit.

16. The power converter system according to claim 15, wherein the first and second controllers are proportional-integral controllers.

17. The power converter system according to claim 15, wherein the second control path comprises a third controller configured to receive a difference between the flying capacitor voltage and a reference voltage as input and wherein the second control path further comprises a multiplication block configured to multiply the output of the third controllerwith the sign of the inductor current obtained by a sign function block to form the voltage control signal.

18. The power converter system according to claim 17, wherein the third controller is a proportional-integral controller.

19. The power converter system according to claim 15, wherein the control system further comprises a compensation circuit arrangement for compensating the influence of the voltage control signal on an average value of the inductor current over a switching cycle, the compensation circuit arrangement configured to receive a positive compensation voltage control signal and a negative compensation voltage control signal from the second control path, the compensation circuit arrangement configured to generate a compensation control signal for input into the switch control circuit.

20. The power converter system according to claim 19, wherein the second control path comprises a first saturation block and second saturation block configured to receive the voltage control signal, the first saturation block having a lower limit of 0 and an upper limit of a fixed positive value and the second saturation having an upper limit of 0 and a lower limit of a fixed negative value, the first saturation block configured to output a positive compensation voltage control signal and the second saturation block configured to output a negative compensation voltage control signal, the compensation circuit arrangement configured to receive said positive and negative compensation voltage control signals.

21. The power converter system according to claim 19, wherein the compensation circuit arrangement is configured to output the compensation control signal according to the formula Tx=(UC1−UC3)/UC2*Tup−(UC2−UC3)/UC1*Tun.

22. The power converter system according to claim 19, wherein the switch control circuit comprises a first subtraction block configured to add the current control signal and voltage control signal and subtract the compensation control signal, and a second subtraction block configured to add the current control signal and subtract the voltage control signal and compensation control signal.

23. The power converter system according to claim 22, wherein each of the first and second subtraction blocks is configured to add a reference value.

24. The power converter system according to claim 15, wherein the gate control circuit is configured to generate first and second PWM carrier signals and further comprises a first comparator configured to compare the output of the first subtraction block with the first PWM carrier signal and a second comparator configured to compare the output of the second subtraction block with the second PWM carrier signal

25. The power converter system according to claim 24, wherein the first and second PWM carrier signals have the same frequency and amplitude, and have substantially triangular waveforms, whereby the first PWM carrier signal is 180° phase shifted from the second PWM carrier signal.

26. The power converter system according to claim 24, wherein the plurality of switches are transistors and the output of the comparators constitute transistor gate input signals.

27. The power converter system according to claim 19, wherein the switch control circuit is configured to generate switch control signals to control operation of the plurality of switches of the balancing circuit, wherein the switch control signals are periodic and include two switching states per switching cycle if Tu=Tx=Ti=0 and three switching states per switching cycle otherwise.

28. The power converter system according to claim 15, wherein the multi-level inverter is a three-level inverter.
